(19) United States
(12) Patent Application Publication
(10) Pub. No.: US 2025/0292937 A1
(43) Pub. Date: Sep. 18, 2025

(54) COIL COMPONENT

(71) Applicant: TDK Corporation, Tokyo (JP)

(72) Inventors: Hidenori TSUTSUI, Tokyo (JP); Kouji KAWAMURA, Tokyo (JP); Hibiki MIYASAKA, Tokyo (JP); Takeshi OKUMURA, Tokyo (JP); Kenichi HIRENZAKI, Tokyo (JP); Takafumi ONO, Tokyo (JP)

(21) Appl. No.: 19/042,266

(22) Filed: Jan. 31, 2025

(30) Foreign Application Priority Data
Mar. 18, 2024 (JP) 2024-042502

(51) Int. Cl. H01F 5/00

(52) U.S. Cl. CPC H01F 5/003

(57) ABSTRACT

Disclosed herein is a coil component that includes first and second coil patterns. The first coil pattern includes first and second turns adjacent to each other. The second coil pattern includes third and fourth turns adjacent to each other. The first turn includes first and second sections. The third turn includes third to fifth sections. The first and third sections overlap each other. The second and fourth sections overlap each other. The space between second section and the second turn increases as advancing in the winding direction. The space between fourth section and the fourth turn increases as advancing in the winding direction. The fifth section does not overlap the first turn. The space between the fifth section and the fourth turn decreases as advancing in the winding direction.

### CROSS-REFERENCE TO RELATED APPLICATION

This application claims the benefit of Japanese Patent Application No. 2024-042502, filed on Mar. 18, 2024, the entire disclosure of which is incorporated by reference herein.

### BACKGROUND OF THE ART

### Field of the Art

The present disclosure relates to a coil component and, more particularly, to a coil component having a plurality of coil patterns stacked through an insulating layer.

### Description of Related Art

JP 2020-202392A discloses a chip-type coil component having two coil patterns in upper and lower layers stacked through an insulating layer. In this coil component, a dummy pattern is added to the lower-layer coil pattern so as to prevent process conditions at formation of the upper-layer coil pattern from deteriorating due to unevenness of the insulating layer generated by the lower-layer coil pattern.

However, adding the dummy pattern to the coil pattern has an influence on high-frequency characteristics. For example, signals are reflected by the dummy pattern.

### SUMMARY

The present disclosure describes a technology for improving, in a coil component having a plurality of coil patterns stacked through an insulating layer, process conditions at formation of the upper-layer coil pattern without using the dummy pattern.

A coil component according to an aspect of the present disclosure includes: a first coil pattern spirally wound in a plurality of turns; and a second coil pattern stacked on the first coil pattern through an insulating layer and spirally wound in a plurality of turns. The first coil pattern includes a first turn positioned on the innermost peripheral side and a second turn adjacent to the first turn. The second coil pattern includes a third turn positioned on the innermost peripheral side and a fourth turn adjacent to the third turn. The first turn includes a first section spaced apart from the second turn by a first distance and a second section positioned closer to the inner peripheral end than the first section, spaced apart from the second turn by a distance larger than the first distance, and the space between which and the second turn increases as advancing in the winding direction from the outer peripheral end to the inner peripheral end of the first coil pattern. The third turn includes a third section spaced apart from the fourth turn by the first distance and extending along the first section of the first turn so as to overlap the first section as viewed from the stacking direction, a fourth section positioned closer to the inner peripheral end than the third section, extending along the second section of the first turn so as to overlap the second section as viewed from the stacking direction, spaced apart from the fourth turn by a distance larger than the first distance, and the space between which and the fourth turn increases as advancing in the winding direction from the outer peripheral end to the inner peripheral end of the second coil pattern, and a fifth section positioned closer to the inner peripheral end than the fourth section, extending without overlapping the first turn as viewed in the stacking direction, and the space between which and the fourth turn decreases as advancing in the winding direction from the outer peripheral end to the inner peripheral end of the second coil pattern.

A coil component according to another aspect of the present disclosure includes: a first coil pattern spirally wound in a plurality of turns; and a second coil pattern stacked on the first coil pattern through an insulating layer and spirally wound in a plurality of turns. The first coil pattern includes a first turn positioned on the outermost peripheral side and a second turn adjacent to the first turn. The second coil pattern includes a third turn positioned on the outermost peripheral side and a fourth turn adjacent to the third turn. The first turn includes a first section spaced apart from the second turn by a first distance and a second section positioned closer to the outer peripheral end than the first section, spaced apart from the second turn by a distance larger than the first distance, and the space between which and the second turn increases as advancing in the winding direction from the inner peripheral end to the outer peripheral end of the first coil pattern. The third turn includes a third section spaced apart from the fourth turn by the first distance and extending along the first section of the first turn so as to overlap the first section as viewed from the stacking direction, a fourth section positioned closer to the outer peripheral end than the third section, extending along the second section of the first turn so as to overlap the second section as viewed from the stacking direction, spaced apart from the fourth turn by a distance larger than the first distance, and the space between which and the fourth turn increases as advancing in the winding direction from the inner peripheral end to the outer peripheral end of the second coil pattern, and a fifth section positioned closer to the outer peripheral end than the fourth section, extending without overlapping the first turn as viewed in the stacking direction, and the space between which and the fourth turn decreases as advancing in the winding direction from the inner peripheral end to the outer peripheral end of the second coil pattern.

### BRIEF DESCRIPTION OF THE DRAWINGS

The above features and advantages of the present disclosure will be more apparent from the following description of some embodiments taken in conjunction with the accompanying drawings, in which:

FIG. 1 is a schematic perspective view illustrating the outer appearance of a coil component 1 according to an embodiment of the technology described herein;

FIG. 2 is a schematic plan view for explaining the pattern shape of the conductor layer 100;

FIG. 3 is a schematic plan view of the insulating layer 10;

FIG. 4 is a schematic plan view for explaining the pattern shape of the conductor layer 200;

FIG. 5 is a schematic plan view of the insulating layer 20;

FIG. 6 is a schematic plan view for explaining the pattern shape of the conductor layer 300;

FIG. 7 is a schematic plan view of the insulating layer 30;

FIG. 8 is an equivalent circuit diagram of the coil component 1;

FIG. 9 is a schematic enlarged view illustrating a state where the coil patterns 110 and 210 overlap each other;

FIG. 10 is a view for explaining a pattern shape according to a comparative example;

FIGS. 11 and 12 are typical cross-sectional views for explaining a problem in the comparative example illustrated in FIG. 10; and

FIG. 13 is a schematic plan view for explaining the pattern shape of a conductor layer 200A according to a modification.

### DETAILED DESCRIPTION OF THE EMBODIMENTS

Some embodiments of the present disclosure will be explained below in detail with reference to the accompanying drawings.

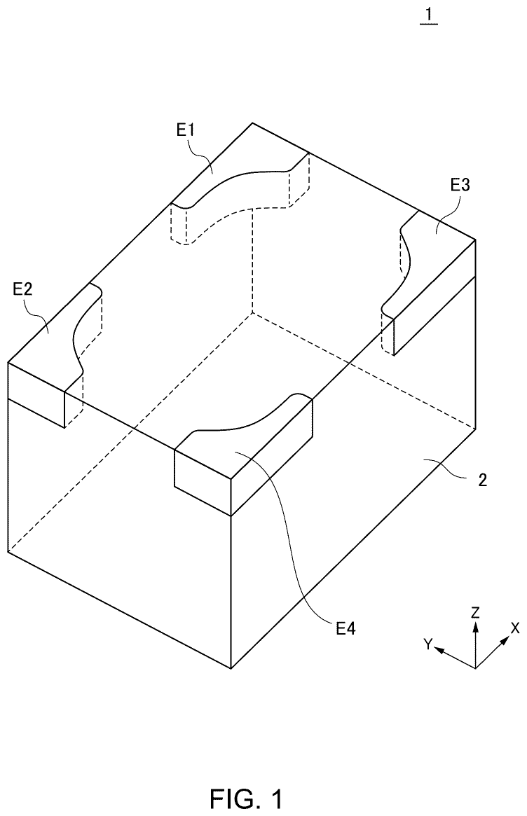

FIG. 1 is a schematic perspective view illustrating the outer appearance of a coil component 1 according to an embodiment of the technology described herein.

The coil component 1 according to the first embodiment is a surface-mount type chip component functioning as a common mode filter and includes, as illustrated in FIG. 1, an element body 2 and four terminal electrodes E1 to E4 embedded in the element body 2. As described later, the element body 2 embeds therein three conductor layers 100, 200, and 300 which are stacked one on another through insulating layers.

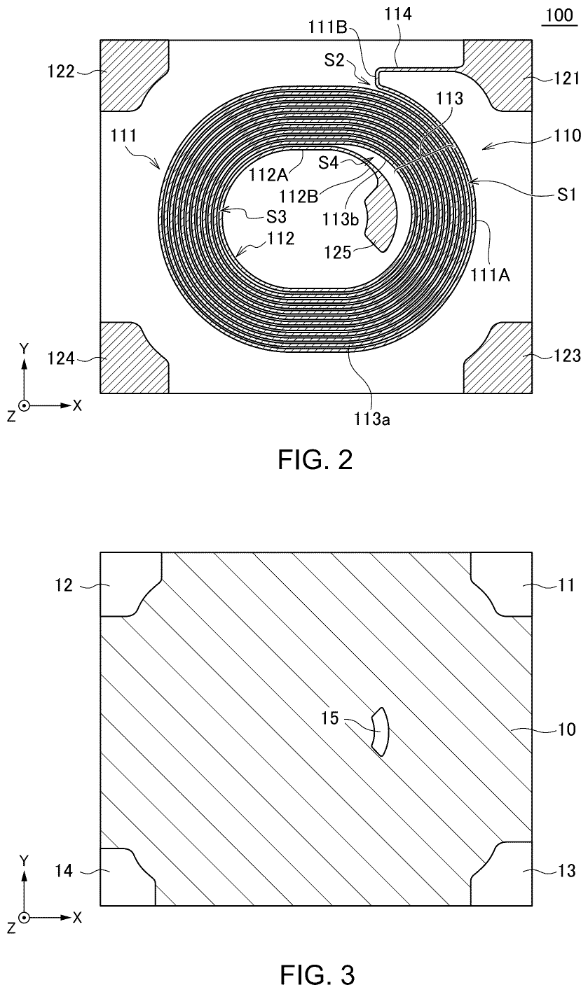

FIG. 2 is a schematic plan view for explaining the pattern shape of the conductor layer 100.

The conductor layer 100 is the lowermost conductor layer and has a spiral coil pattern 110 and connection patterns 121 to 125. In the example illustrated in FIG. 2, the coil pattern 110 has about 12 turns and includes an outermost turn 111, an innermost turn 112, and an intermediate turn 113 positioned between (inclusive) a second turn (turn 113a) counting from the outermost peripheral side which is wound adjacent to the outermost turn 111 and a second turn (turn 113b) counting from the innermost peripheral side which is wound adjacent to the innermost turn 112. The intermediate turn 113 has about 10 turns. The outer peripheral end of the coil pattern 110 is connected to the connection pattern 121 by way of a lead-out part 114. The inner peripheral end of the coil pattern 110 is connected to the connection pattern 125. The coil pattern 110 is wound right-handed (clockwise) from the outer peripheral end to the inner peripheral end, whereas the lead-out part 114 linearly extends in the negative X-direction from the outer peripheral end to the inner peripheral end without being wound right-handed (clockwise). The connection patterns 122 to 124 are each independently provided without being connected to another conductor pattern in the conductor layer 100.

The outermost turn 111 of the coil pattern 110 includes sections 111A and 111B. The section 111A extends along the turn 113a. A constant space S1 between the section 111A and the turn 113a is substantially constant. The section 111B is positioned closer to the outer peripheral end than the section 111A. A space S2 between the section 111B and the turn 113a increases in a winding direction from the inner peripheral end of the coil pattern 110 toward the outer peripheral end thereof. The space S2 between the section 111B and the turn 113a is larger than the space S1 between the section 111A and the turn 113a.

The innermost turn 112 of the coil pattern 110 includes sections 112A and 112B. The section 112A extends along the turn 113b. A constant space S3 between the section 112A and the turn 113b is substantially constant. The section 112B is positioned closer to the inner peripheral end than the section 112A. A space S4 between the section 112B and the turn 113b increases in a winding direction from the outer peripheral end of the coil pattern 110 toward the inner peripheral end thereof. The space S4 between the section 112B and the turn 113b is larger than the space S3 between the section 112A and the turn 113b. The space S1 and the space S3 may have the same size.

FIG. 3 is a schematic plan view of the insulating layer 10.

The insulating layer 10 is positioned between the conductor layers 100 and 200 and has openings 11 to 15. The openings 11 to 15 are formed at positions respectively exposing therethrough the connection patterns 121 to 125.

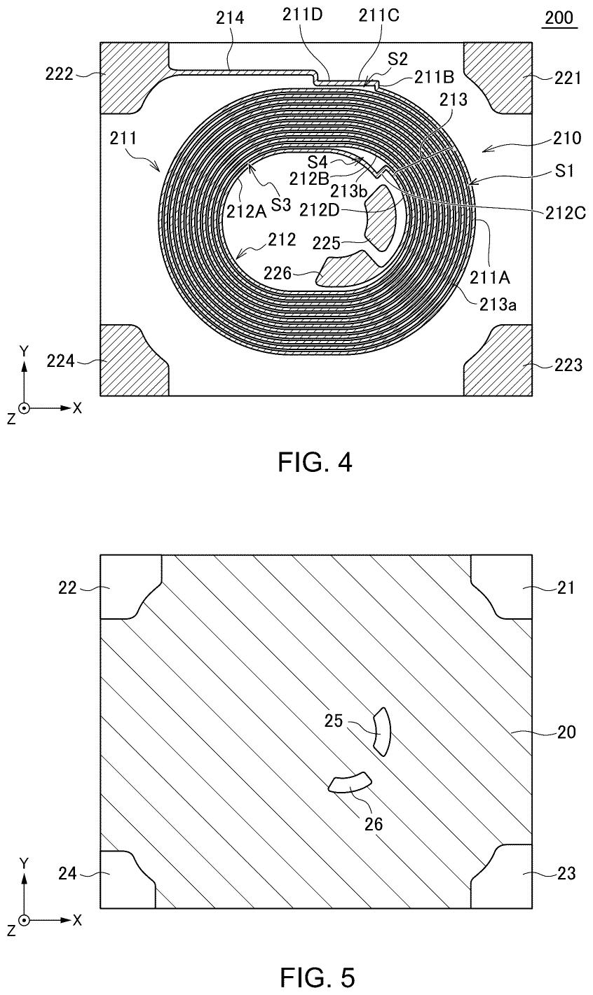

FIG. 4 is a schematic plan view for explaining the pattern shape of the conductor layer 200.

The conductor layer 200 has a spiral coil pattern 210 and connection patterns 221 to 226. In the example illustrated in FIG. 4, the coil pattern 210 has about 12 turns and includes an outermost turn 211, an innermost turn 212, and an intermediate turn 213 positioned between (inclusive) a second turn (turn 213a) counting from the outermost peripheral side to a second turn (turn 213b) counting from the innermost The peripheral side. intermediate turn 213 has about 10 turns. That is, the number of turns of the coil pattern 110 and that of the coil pattern 210 are substantially the same. When there is a difference between the numbers of turns of the coil patterns 110 and 210 due to the position of the lead-out part or the like, the difference in the number of turns is preferably ½ or less in order to achieve a function as a common mode filter.

The outer peripheral end of the coil pattern 210 is connected to the connection pattern 222 by way of a lead-out part 214. The inner peripheral end of the coil pattern 210 is connected to the connection pattern 226. The coil pattern 210 is wound right-handed (clockwise) from the outer peripheral end to the inner peripheral end, whereas the lead-out part 214 linearly extends in the positive X-direction from the outer peripheral end to the inner peripheral end. The connection patterns 221, 223, 224, and 225 are each independently provided without being connected to another conductor pattern in the conductor layer 200. The connection patterns 221 to 225 are connected respectively to the connection patterns 121 to 125 through the respective openings 11 to 15 formed in the insulating layer 10.

The outermost turn 211 of the coil pattern 210 includes sections 211A, 211B, 211C, and 211D. The section 211A has substantially the constant space S1 between itself and the turn 213a and extends along the section 111A of the coil pattern 110 so as to overlap the section 111A of the coil pattern 110 as viewed in the Z-direction (stacking direction). The section 211B is positioned closer to the outer peripheral end than the section 211A and extends along the section 111B of the coil pattern 110 so as to overlap the section 111B of the coil pattern 110 as viewed in the Z-direction. The space S2 between the section 211B and the turn 213a increases as advancing in the winding direction from the inner peripheral end of the coil pattern 210 toward the outer peripheral end thereof. The section 211C is positioned closer to the outer peripheral end than the section 211B and does not overlap the outermost turn 111 of the coil pattern 110 as viewed in the Z-direction.

The space between the section 211C and the turn 213a decreases as advancing in the winding direction from the inner peripheral end of the coil pattern 210 toward the outer peripheral end thereof. The section 211D is positioned closer to the outer peripheral end than the section 211C and does not overlap the outermost turn 111 of the coil pattern 110 as viewed in the Z-direction. The space S1 between the section 211D and the turn 213a is substantially constant.

The innermost turn 212 of the coil pattern 210 includes sections 212A, 212B, 212C, and 212D. The section 212A has substantially the constant space S1 between itself and the turn 213b and extends along the section 112A of the coil pattern 110 so as to overlap the section 112A of the coil pattern 110 as viewed in the Z-direction (stacking direction). The section 212B is positioned closer to the inner peripheral end than the section 212A and extends along the section 112B of the coil pattern 110 so as to overlap the section 112B of the coil pattern 110 as viewed in the Z-direction. A space S4 between the section 212B and the turn 213b increases as advancing in the winding direction from the outer peripheral end of the coil pattern 210 toward the inner peripheral end thereof. The section 212C is positioned closer to the inner peripheral end than the section 212B and does not overlap the innermost turn 112 of the coil pattern 110 as viewed in the Z-direction. The space between the section 212C and the turn 213b decreases as advancing in the winding direction from the outer peripheral end of the coil pattern 210 toward the inner peripheral end thereof. The section 212D is positioned closer to the inner peripheral end than the section 212C and does not overlap the innermost turn 112 of the coil pattern 110 as viewed in the Z-direction. The space S1 between the section 212D and the turn 213b is substantially constant.

FIG. 5 is a schematic plan view of the insulating layer 20.

The insulating layer 20 is positioned between the conductor layers 200 and 300 and has openings 21 to 26. The openings 21 to 26 are formed at positions respectively exposing therethrough the connection patterns 221 to 226.

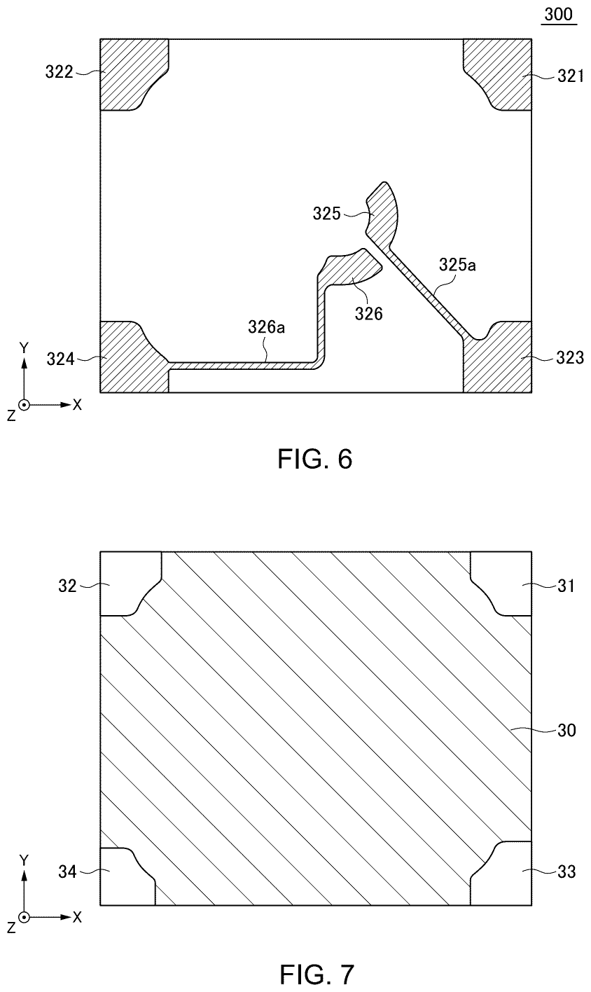

FIG. 6 is a schematic plan view for explaining the pattern shape of the conductor layer 300.

The conductor layer 300 has connection patterns 321 to 326. The connection patterns 321 to 326 are connected respectively to the connection patterns 221 to 226 through the respective openings 21 to 26 formed in the insulating layer 20. Further, the connection pattern 325 is connected to the connection pattern 323 through a lead-out part 325a, and the connection pattern 326 is connected to the connection pattern 324 through a lead-out part 326a.

FIG. 7 is a schematic plan view of the insulating layer 30.

The insulating layer 30 is the uppermost insulating layer and has openings 31 to 34. The openings 31 to 34 are formed at positions respectively exposing therethrough the connection patterns 321 to 324. The terminal electrodes E1 to E4 illustrated in FIG. 1 are connected respectively to the connection patterns 321 to 324 through the respective openings 31 to 34.

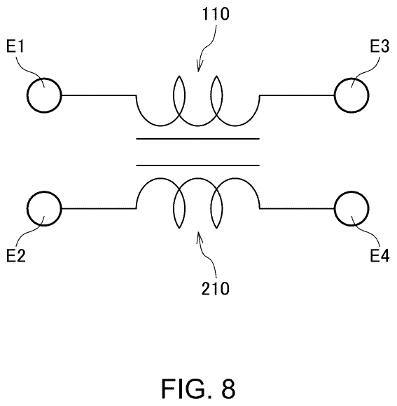

With the above configuration, the outer peripheral end of the coil pattern 110 is connected to the terminal electrode E1, the outer peripheral end of the coil pattern 210 is connected to the terminal electrode E2, the inner peripheral end of the coil pattern 110 is connected to the terminal electrode E3, and the inner peripheral end of the coil pattern 210 is connected to the terminal electrode E4. As a result, as illustrated in FIG. 8, the coil pattern 110 connected between the terminal electrodes E1 and E3 and the coil pattern 210 connected between the terminal electrodes E2 and E4 are couped to each other.

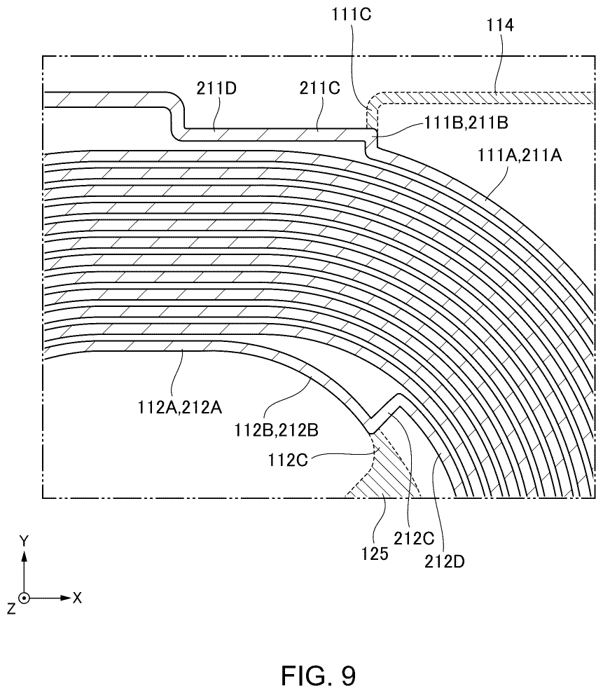

FIG. 9 is a schematic enlarged view illustrating a state where the coil patterns 110 and 210 overlap each other.

As illustrated in FIG. 9, the section 111A of the outermost turn 111 of the coil pattern 110 and the section 211A of the outermost turn 211 of the coil pattern 210 substantially coincide with each other in planar position as viewed in the Z-direction and thus substantially completely overlap each other. Similarly, the section 111B of the outermost turn 111 of the coil pattern 110 and the section 211B of the outermost turn 211 of the coil pattern 210 substantially coincide with each other in planar position as viewed in the Z-direction and thus substantially completely overlap each other. The outermost turn 111 of the coil pattern 110 is connected to the lead-out part 114 by way of a section 111C positioned closer to the outer peripheral end than the section 111B and extending from the section 111B in its extending direction.

On the other hand, the outermost turn 211 of the coil pattern 210 is bent radially outward at a substantially right angle at a part thereof between the sections 211B and 211C, with the result that the section 111C of the outermost turn 111 of the coil pattern 110 does not overlap the coil pattern 210. The sections 211C and 211D of the coil pattern 210 also do not overlap the coil pattern 110.

As illustrated in FIG. 9, the section 112A of the innermost turn 112 of the coil pattern 110 and the section 212A of the innermost turn 212 of the coil pattern 210 substantially coincide with each other in planar position as viewed in the Z-direction and thus substantially completely overlap each other. Similarly, the section 112B of the innermost turn 112 of the coil pattern 110 and the section 212B of the innermost turn 212 of the coil pattern 210 substantially coincide with each other in planar position as viewed in the Z-direction and thus substantially completely overlap each other. The innermost turn 112 of the coil pattern 110 is connected to the connection pattern 125 by way of a section 112C positioned closer to the inner peripheral end than the section 112B and extending from the section 112B in its extending direction.

On the other hand, the innermost turn 212 of the coil pattern 210 is bent radially inside at a substantially right angle at a part thereof between the sections 212B and 212C, with the result that the section 112C of the innermost turn 112 of the coil pattern 110 does not overlap the coil pattern 210. The sections 212C and 212D of the coil pattern 210 also do not overlap the coil pattern 110.

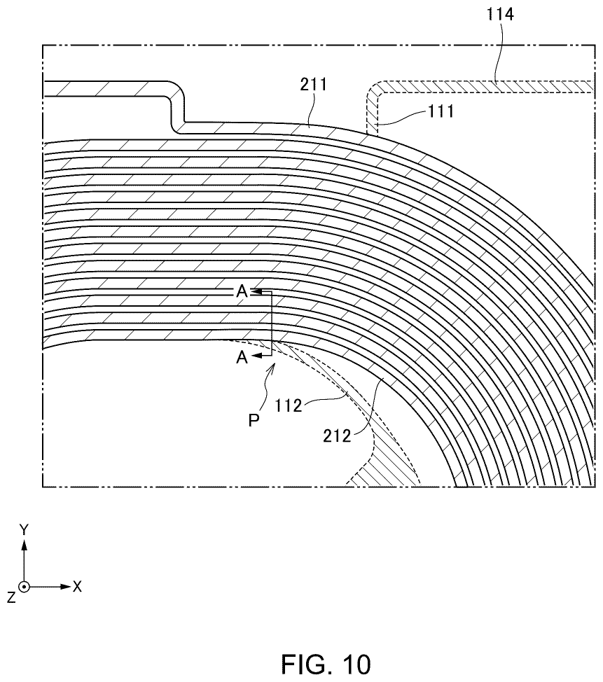

FIG. 10 is a view for explaining a pattern shape according to a comparative example. In this example, the outermost turn 211 of the coil pattern 210 has neither the section 211B nor section 211C, and the innermost turn 212 of the coil pattern 210 has neither the section 212B nor section 212C. That is, in the comparative example illustrated in FIG. 10, the coil pattern 210 positioned in the upper layer has a simple spiral shape.

As illustrated in FIG. 10, when the coil pattern 210 has a simple spiral shape, and the innermost turn 212 of the coil pattern 210 neither has the section 212B nor section 212C, there is formed an area P where the innermost turn 112 of the coil pattern 110 and the innermost turn 212 of the coil pattern 210 are gradually separated in planar position from each other as advancing in the winding direction from the outer peripheral end to the inner peripheral end.

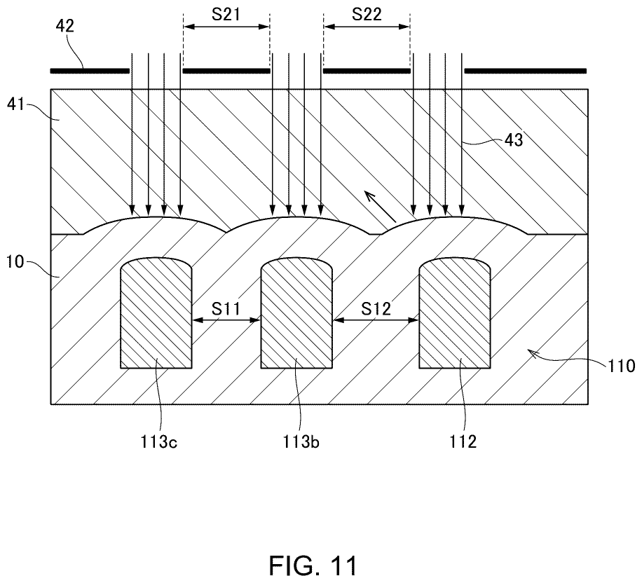

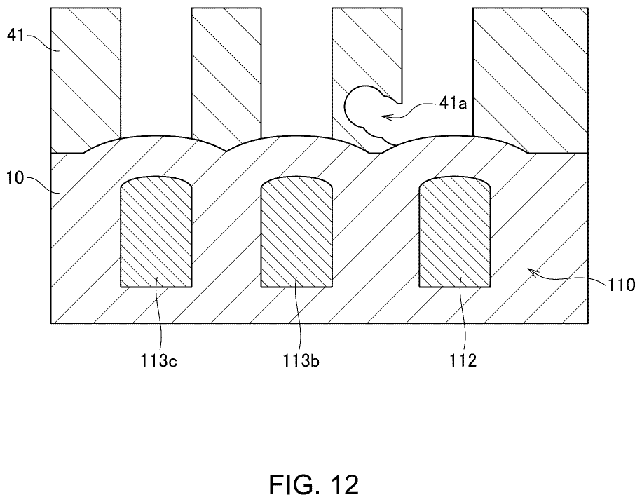

FIGS. 11 and 12 are typical cross-sectional views for explaining a problem in the comparative example illustrated in FIG. 10. More specifically, FIGS. 11 and 12 are cross-sectional process views taken along the line A-A in FIG. 10.

As illustrated in FIG. 11, when the coil pattern 210 is formed on the surface of the insulating layer 10 covering the coil pattern 110, a photoresist 41 is formed on the surface of the insulating layer 10, and then an exposing light 43 is irradiated onto the photoresist 41 through a photomask 42. However, in the cross section taken along the line A-A in FIG. 10, a space S12 between the turn 113b, which is the second turn counting from the innermost peripheral side, and the innermost turn 112 is slightly larger than a space S11 between the turns constituting the intermediate turn 113. On the other hand, for the opening portion of the photomask 42, a space S21 between the opening portions for forming the turns constituting the intermediate turn 213 and a space S22 between the opening portion for forming the turn 213b, which is the second turn counting from the innermost peripheral side, and the opening portion for forming the innermost turn 212 are substantially the same in size.

When exposure is performed under such conditions, the light 43 is irradiated from right above the turn 113b and a turn 113c, which is the third turn counting from the innermost peripheral side, whereas for the innermost turn 112, the light 43 is irradiated at a position slightly offset radially outward from a direction right thereabove. Here, the surface of the insulating 10 is not completely flat but has a slightly convex shape at a position overlapping the coil pattern 110, so that the light 43 irradiated onto the position offset outward from the direction right above the innermost turn 112 is reflected radially outward by the convex surface of the insulating layer 10.

As a result, as can be seen from the developing pattern illustrated in FIG. 12 which is formed using the photoresist 41, the bottom portion of the opening pattern for forming the innermost turn 212 radially expands as denoted by reference numeral 41a. Thus, when the innermost turn 212 is formed using such a photoresist pattern, the pattern width of the innermost turn 212 locally increases outward in the radial direction. The local expansion of the pattern width of the innermost turn 212 may cause a short-circuit failure between the innermost turn 212 and the turn 213b in some cases.

On the other hand, in the present embodiment, as illustrated in FIG. 9, the area where the innermost turn 112 of the coil pattern 110 and the innermost turn 212 of the coil pattern 210 are gradually separated in planar position from each other is not formed, and the innermost turn 212 of the coil pattern 210 is bent at a substantially right angle at a portion between the sections 212B and 212C, where the innermost turn 112 of the coil pattern 110 and the innermost turn 212 of the coil pattern 210 are significantly separated from each other in a plan view. Therefore, an exposure failure described using FIGS. 11 and 12 is unlikely to occur. This alleviates process conditions at formation of the coil pattern 210.

Even when a certain level of exposure failure occurs in the substantially right-angled bent area in the vicinity of the sections 212B and 212C, a short-circuit failure is unlikely to occur since there is provided a sufficient space between the bent area and the turn 213b. The same applies to the substantially right-angled bent area in the vicinity of the sections 211B and 211C of the outermost turn 211. That is, even when a certain level of exposure failure occurs in the bent area, a short-circuit failure is unlikely to occur since there is provided a sufficient space between the bent area and the turn 213a.

As described above, the coil component 1 according to the present embodiment, the coil pattern 210 positioned in the upper layer does not have a simple spiral shape but includes the sections 211B and 212B the distances between which and their adjacent turns become larger toward the outer and inner peripheral ends and the sections 211C and 212C the distances between which and their adjacent turns become smaller toward the outer and inner peripheral ends. Therefore, an exposure failure due to the surface unevenness of the insulating layer 10 is unlikely to occur, whereby there can be provided a product with high reliability. In addition, since there is no need to use a dummy pattern, degradation in high frequency characteristics does not occur.

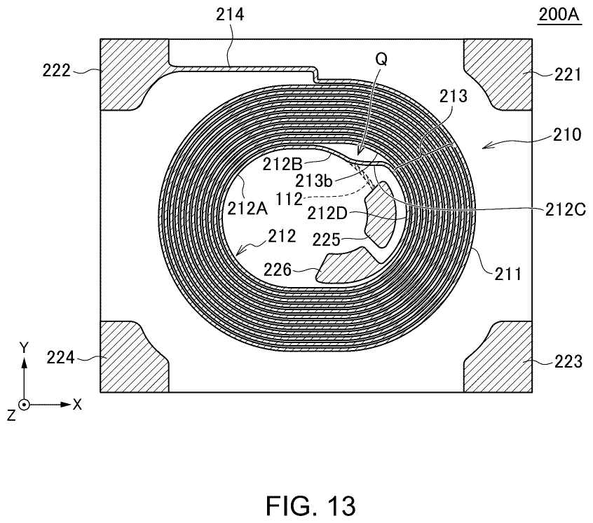

FIG. 13 is a schematic plan view for explaining the pattern shape of a conductor layer 200A according to a modification.

The conductor layer 200A illustrated in FIG. 13 differs from the conductor layer 200 illustrated in FIG. 4 in the following points. That is, the innermost turn 212 is not bent at a right angle between the sections 212B and 212C but extends while being gently curved, and the outermost turn 211 has neither the section 211B nor section 211C to make the space S1 between the outermost turn 211 and the turn 213a substantially constant. Other basic configurations are the same as those of the conductor layer 200 illustrated in FIG. 4, so the same reference numerals are given to the same elements, and overlapping description will be omitted.

In FIG. 13, the planar position of the innermost turn 112 of the coil pattern 110 is partially denoted by the dashed line. In the example illustrated in FIG. 13, the sections 212B and 212C extend while being gently curved, and thus an area Q is formed where the innermost turn 112 of the coil pattern 110 and the innermost turn 212 of the coil pattern 210 are gradually separated in planar position from each other as advancing in the winding direction from the outer peripheral end to the inner peripheral end, so that an exposure failure is likely to occur in the area Q. However, since there is provided a sufficient space between the innermost turn 212 and the turn 213b, a short-circuit does not occur even if there is some small exposure failure.

As exemplified in the modification illustrated in FIG. 13, the innermost turn 212 need not necessarily be bent at a substantially right angle at a portion between the sections 212B and 212C but may extend while being gently curved. Further, the outermost turn 211 needs to have neither the section 211B nor section 211C, and the space S1 between the outermost turn 211 and the turn 213a may be substantially constant.

While some embodiments of the technology according to the present disclosure have been described, the technology according to the present disclosure is not limited to the above embodiments, and various modifications may be made within the scope of the present disclosure, and all such modifications are included in the technology according to the present disclosure.

The technology according to the present disclosure includes the following configuration examples, but not limited thereto.

A coil component according to an aspect of the present disclosure includes: a first coil pattern spirally wound in a plurality of turns; and a second coil pattern stacked on the first coil pattern through an insulating layer and spirally wound in a plurality of turns. The first coil pattern includes a first turn positioned on the innermost peripheral side and a second turn adjacent to the first turn. The second coil pattern includes a third turn positioned on the innermost peripheral side and a fourth turn adjacent to the third turn. The first turn includes a first section spaced apart from the second turn by a first distance and a second section positioned closer to the inner peripheral end than the first section, spaced apart from the second turn by a distance larger than the first distance, and the space between which and the second turn increases as advancing in the winding direction from the outer peripheral end to the inner peripheral end of the first coil pattern. The third turn includes a third section spaced apart from the fourth turn by the first distance and extending along the first section of the first turn so as to overlap the first section as viewed from the stacking direction, a fourth section positioned closer to the inner peripheral end than the third section, extending along the second section of the first turn so as to overlap the second section as viewed from the stacking direction, spaced apart from the fourth turn by a distance larger than the first distance, and the space between which and the fourth turn increases as advancing in the winding direction from the outer peripheral end to the inner peripheral end of the second coil pattern, and a fifth section positioned closer to the inner peripheral end than the fourth section, extending without overlapping the first turn as viewed in the stacking direction, and the space between which and the fourth turn decreases as advancing in the winding direction from the outer peripheral end to the inner peripheral end of the second coil pattern. With this configuration, a short-circuit failure is unlikely to occur in the innermost turn of the second coil pattern.

In the above coil component, the third turn may include a sixth section positioned closer to the inner peripheral end than the fifth section and spaced apart from the fourth turn by the first distance. This increases inductance due to the presence of the sixth section.

A coil component according to another aspect of the present disclosure includes: a first coil pattern spirally wound in a plurality of turns; and a second coil pattern stacked on the first coil pattern through an insulating layer and spirally wound in a plurality of turns. The first coil pattern includes a first turn positioned on the outermost peripheral side and a second turn adjacent to the first turn. The second coil pattern includes a third turn positioned on the outermost peripheral side and a fourth turn adjacent to the third turn. The first turn includes a first section spaced apart from the second turn by a first distance and a second section positioned closer to the outer peripheral end than the first section, spaced apart from the second turn by a distance larger than the first distance, and the space between which and the second turn increases as advancing in the winding direction from the inner peripheral end to the outer peripheral end of the first coil pattern. The third turn includes a third section spaced apart from the fourth turn by the first distance and extending along the first section of the first turn so as to overlap the first section as viewed from the stacking direction, a fourth section positioned closer to the outer peripheral end than the third section, extending along the second section of the first turn so as to overlap the second section as viewed from the stacking direction, spaced apart from the fourth turn by a distance larger than the first distance, and the space between which and the fourth turn increases as advancing in the winding direction from the inner peripheral end to the outer peripheral end of the second coil pattern, and a fifth section positioned closer to the outer peripheral end than the fourth section, extending without overlapping the first turn as viewed in the stacking direction, and the space between which and the fourth turn decreases as advancing in the winding direction from the inner peripheral end to the outer peripheral end of the second coil pattern. With this configuration, a short-circuit failure is unlikely to occur in the outermost turn of the second coil pattern.

In the above coil component, the third turn may include a sixth section positioned closer to the outer peripheral end than the fifth section and spaced apart from the fourth turn by the first distance. This increases inductance due to the presence of the sixth section.

In the above coil component, the first turn of the first coil pattern may further include a seventh section extending in the extending direction of the second section, and the seventh section may not overlap the second coil pattern as viewed in the stacking direction. This can make the pattern shape of the first coil pattern simple.

In the above coil component, the second coil pattern may be bent in a substantially right angle at a portion between the fourth and fifth sections. This makes defective formation of the second coil pattern unlikely to occur at the portion between the fourth and fifth sections.

What is claimed is:

1. A coil component comprising:
a first coil pattern spirally wound in a plurality of turns; and
a second coil pattern stacked on the first coil pattern through an insulating layer and spirally wound in a plurality of turns,
wherein the first coil pattern includes a first turn positioned on an innermost peripheral side and a second turn adjacent to the first turn,
wherein the second coil pattern includes a third turn positioned on an innermost peripheral side and a fourth turn adjacent to the third turn,
wherein the first turn of the first coil pattern includes:
a first section spaced apart from the second turn of the first coil pattern by a first distance; and
a second section positioned closer to an inner peripheral end of the first coil pattern than the first section of the first turn, spaced apart from the second turn by a distance larger than the first distance, and a space between which and the second turn increases as advancing in a winding direction from an outer peripheral end to the inner peripheral end of the first coil pattern,
wherein the third turn of the second coil pattern includes:
a third section spaced apart from the fourth turn of the second coil pattern by the first distance and extending along the first section of the first turn of the first coil pattern so as to overlap the first section of first turn of the first coil pattern as viewed from a stacking direction;
a fourth section positioned closer to an inner peripheral end of the second coil pattern than the third section of the third turn of second coil pattern, extending along the second section of the first turn of the first coil pattern so as to overlap the second section of the first turn of the first coil pattern as viewed from the stacking direction, spaced apart from the fourth turn of the second coil pattern by a distance larger than the first distance, and a space between which and the fourth turn of the second coil pattern increases as advancing in the winding direction from an outer peripheral end to the inner peripheral end of the second coil pattern; and
a fifth section positioned closer to the inner peripheral end than the fourth section of the third turn of the second coil pattern, extending without overlapping the first turn of the first coil pattern as viewed in the stacking direction, and a space between which and the fourth turn of the second coil pattern decreases as advancing in the winding direction from the outer peripheral end to the inner peripheral end of the second coil pattern.

2. The coil component as claimed in claim 1, wherein the third turn of the second coil pattern further includes a sixth section positioned closer to the inner peripheral end of the second coil pattern than the fifth section of the third turn of the second coil pattern and spaced apart from the fourth turn of the second coil pattern by the first distance.

3. The coil component as claimed in claim 1,
wherein the first turn of the first coil pattern further includes a seventh section extending in an extending direction of the second section, and
wherein the seventh section does not overlap the second coil pattern as viewed in the stacking direction.

4. The coil component as claimed in claim 3, wherein the second coil pattern is bent in a substantially right angle at a portion between the fourth and fifth sections.

5. A coil component comprising:
a first coil pattern spirally wound in a plurality of turns; and
a second coil pattern stacked on the first coil pattern through an insulating layer and spirally wound in a plurality of turns,
wherein the first coil pattern includes a first turn positioned on an outermost peripheral side and a second turn adjacent to the first turn,
wherein the second coil pattern includes a third turn positioned on an outermost peripheral side and a fourth turn adjacent to the third turn,
wherein the first turn of the first coil pattern includes:
a first section spaced apart from the second turn of the first coil pattern by a first distance; and
a second section positioned closer to an outer peripheral end of the first coil pattern than the first section of the first turn, spaced apart from the second turn by a distance larger than the first distance, and a space between which and the second turn increases as advancing in a winding direction from an inner peripheral end to the outer peripheral end of the first coil pattern,
wherein the third turn of the second coil pattern includes:
a third section spaced apart from the fourth turn of the second coil pattern by the first distance and extending along the first section of the first turn of the first coil pattern so as to overlap the first section of first turn of the first coil pattern as viewed from a stacking direction;
a fourth section positioned closer to an outer peripheral end of the second coil pattern than the third section of the third turn of the second coil pattern, extending along the second section of the first turn of the first coil pattern so as to overlap the second section of the first turn of the first coil pattern as viewed from the stacking direction, spaced apart from the fourth turn of the second coil pattern by a distance larger than the first distance, and a space between which and the fourth turn of the second coil pattern increases as advancing in the winding direction from an inner peripheral end to the outer peripheral end of the second coil pattern; and
a fifth section positioned closer to the outer peripheral end than the fourth section of the third turn of the second coil pattern, extending without overlapping the first turn of the first coil pattern as viewed in the stacking direction, and a space between which and the fourth turn of the second coil pattern decreases as advancing in the winding direction from the inner peripheral end to the outer peripheral end of the second coil pattern.

6. The coil component as claimed in claim 5, wherein the third turn of the second coil pattern further includes a sixth section positioned closer to the outer peripheral end of the second coil pattern than the fifth section of the third turn of the second coil pattern and spaced apart from the fourth turn of the second coil pattern by the first distance.

7. The coil component as claimed in claim 5,
wherein the first turn of the first coil pattern further includes a seventh section extending in an extending direction of the second section, and
wherein the seventh section does not overlap the second coil pattern as viewed in the stacking direction.

8. The coil component as claimed in claim 7, wherein the second coil pattern is bent in a substantially right angle at a portion between the fourth and fifth sections.
